(19) United States
(12) Patent Application Publication
(10) Pub. No.: US 2008/0101297 A1
(43) Pub. Date: May 1, 2008

(54) DVB-H-GPS coexistence on a single antenna solution

(76) Inventors: Istvan Szini, Grayslake, IL (US); Ed Naddeo, Vernon Hills, IL (US)

Correspondence Address: PHILIP H. BURRUS, IV, 460 Grant Street, Atlanta, GA, 30312, US

(21) Appl. No.: 11/553,915

(22) Filed: Oct. 27, 2006

(51) Int. Cl. H04Q 7/00

(52) U.S. Cl. 370/332

(57) ABSTRACT

A single, dual band antenna (101) is configured to receive multiple signals. The single, dual band antenna (101) is selectively coupled to either a first signal receiver (105) or a second receiver (107). In one embodiment, the first signal receiver (105) is configured to receive a time-slotted, multicast signal. Such a signal delivers data in short bursts at specified times. Between bursts, a switch (109) couples the second signal receiver (105) to the single, dual band antenna (101) to acquire the second signal. In one embodiment, the first signal receiver (105) is a DVB—H receiver and the second signal receiver (107) is a GPS or AGPS receiver.

### BACKGROUND

1. Technical Field

The invention relates generally to antennas for portable electronic devices, and more particularly to a single antenna suitable for receiving multiple signals from multiple sources.

2. Background Art

Portable electronic devices are becoming more and more sophisticated. Not too long ago, devices such as mobile telephones were only capable of making voice calls. Today, they are capable of transmitting and receiving not only voice, but also text, pictures, and music. Additionally, some mobile telephones are even capable of surfing the Internet.

These multiple functions work well when each application—e.g. text messaging, multi-media messaging, and Internet browsing—are supported with the same technology. For instance, when using Code Division Multiple Access (CDMA) communication protocols, packets.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a dual-mode, single antenna system in accordance with the invention.

FIG. 2 illustrates one embodiment of a switching timing diagram for use with a dual antenna system in accordance with the invention.

FIG. 3 illustrates one embodiment of a method for a dual-mode, single antenna system in accordance with the invention.

FIG. 4 illustrates substeps of the method of FIG. 3, in accordance with one embodiment of the invention.

FIG. 5 illustrates a cut-away view of one embodiment of an electronic device in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a dual band antenna circuit. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of switching and using a dual band antenna circuit as described herein. The non-processor circuits may include, but are not limited to, a radio receiver, a radio transmitter, signal drivers, clock circuits, power source circuits, and user input devices. As such, these functions may be interpreted as steps of a method to perform dual band antenna usage. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

As shown and described herein, a single antenna is used with a radio frequency switch to multiplex so as to receive two signals. Embodiments of the invention allow electronic devices, such as mobile telephones for instance, to receive multiple signals with a single antenna structure, thereby reducing the overall cost and complexity of the electronic device. Additionally, as fewer components are employed, the mean time between failure (MTBF) for the overall device is increased.

In one embodiment, a single antenna structure is used to receive both digital video broadcasts and global positioning information. For instance, one application for the one embodiment of the invention is to receive both Digital Video Broadcast—Handheld (DVB—H) signals from a terrestrial tower and Global Positioning System (GPS) or Assisted Global Positioning System (AGPS) from either satellite or terrestrial base stations. While the DVB—H/GPS embodiment will be used for discussion purposes herein as an exemplary embodiment, it will be clear to those of ordinary skill in the art having the benefit of this disclosure that the invention is not so limited. Other systems with similar transmission characteristics, perhaps operating in different spectra, could equally be substituted and received with systems and methods as described herein.

Continuing with the exemplary embodiment, DVB—H is a commonly used transmission standard falling within the Digital Video Broadcast (DVB) standard. It implements video transmission suitable for handheld, battery-operated devices. DVB—H is used, for example, to allow people to watch video clips, shows, or movies on handheld devices such as mobile telephones or personal digital assistants.

To reduce the power requirements for portable devices, thereby increasing battery-operating time, DVB—H employs a time slicing technique in which data is transmitted at select moments in time. The data is “burst” in small time slots. By way of example, DVB—H may transmit bursts of up to two megabits of data. This data, which is sent in a short period of time, may then be stored in a memory device or buffer. While there can be many channels or burst services in a DVB—H data stream, at any one time, a portable device is generally tuned to only a single channel or service. The present invention takes advantage of the time slicing associated with DVB—H and other similar signals to acquire additional signals, such as GPS or AGPS, while the first signal is inactive.

DVB—H employs three different spectra to transmit signals. A first band, known as VHF-III, is in the range of 174 to 230 MHz. A second band, known as UHF-IV/V, operates in the 470 to 830 MHz range. A third band, known as the DVB—H L band, can encompass 1670 to 1675 MHz. While the conventional “L band” of the electromagnetic spectrum is anywhere from approximately 0.39 to 1.55 GHz, the “L band” referred to in the design of DVB—H devices includes frequencies as high as 1675 MHz. Some applications, including digital audio broadcasting employ sub-bands of the L band, such as 1.452 GHz to 1.492 GHz. Global Positioning System devices also employ parts of the L band, including bands centered at 1176.45 MHz (L5), 1227.60 MHz (L2), 1381.05 MHz (L3), and 1575.42 MHz (L1). Embodiments of the present invention employ a single antenna structure capable of operating within portions of the L band to receive both DVB—H L band signals and GPS/AGPS L1 band information. For instance, in one embodiment, GPS signals at 1575.42 MHz and DVB—H signals of between 1670 and 1675 MHz are received and processed with the single antenna structure. The single antenna structure is designed so as to have an extended bandwidth that covers both the L1 band associated with GPS systems and the DVB—H (US) L band. As used herein, the “L band” will refer to frequencies of between 1176 and 1675 MHz. It will be clear to those of ordinary skill in the art having the benefit of this disclosure that alternate or similar frequencies can be used.

To accommodate this exemplary application, an antenna structure having a bandwidth suitable for receiving signals between at least 1.57542 and 1.675 GHz is employed to receive signals in both the DVB—H L band and the GPS L1 band, with suitable tolerances. This antenna structure, in one embodiment, is disposed within a portable electronic device in an upper, aft quadrant, which is particularly well suited for receiving both signals. In accordance with the methods described herein, multiple signals are received by the same antenna structure, thereby offering simultaneous operation without redundant parts.

The antenna structure, in one embodiment, has an operational bandwidth of around 100 MHz so as to accommodate both the DVB—H L band and the GPS L1 band. A switch and associated circuitry then are used to synchronize signal reception with the DVB—H and GPS applications. In one embodiment, the system and method for DVB—H/GPS signal reception uses the DVB—H signal to lead synchronization framing between the two applications.

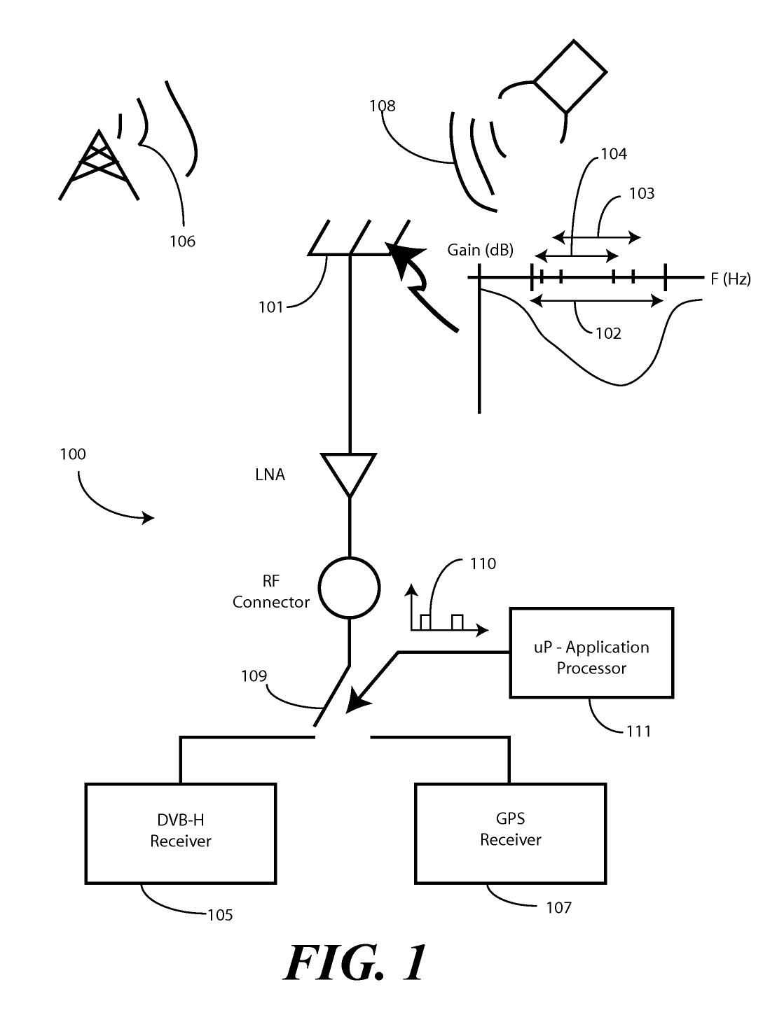

Turning now to FIG. 1, illustrated therein is one embodiment of a dual band antenna circuit 100 in accordance with the invention. The dual band antenna circuit includes a single antenna 101 having an associated bandwidth 102 spanning at least a first transmission signal bandwidth 103 and a second transmission signal bandwidth 104. By way of example using the illustrative embodiment, the single antenna 101 would have an associated bandwidth 102 of at least 100 MHz so as to span both the DVB—H L band and the GPS L1 band. Suitable antennas for use with the invention include inverted-F antennas, planar inverted-F antennas, and folded inverted conformal antennas. It will be clear to those of ordinary skill in the art having the benefit of this disclosure that other antenna structures may also be employed.

A first receiver circuit 105 is configured to receive a first transmission signal 106. Using the exemplary embodiment, the first transmission signal 106 may be a DVB—H signal broadcast from a terrestrial base station. The first transmission signal is characterized by the first transmission signal bandwidth 103, which would be between 1.670 and 1.675 GHz for the DVB—H L band.

A second receiver circuit 107 is configured to receive a second transmission signal 108 that is characterized by the second transmission signal bandwidth 104. Again turning to the exemplary embodiment, the second transmission signal 108 may be the GPS or AGPS signal transmitted from either a terrestrial or satellite base station. The second bandwidth may be the GPS L1 band. Note that it is possible for the first transmission signal bandwidth 103 and second transmission signal bandwidth 104 to overlap, as is the case in the DVB—H/GPS exemplary embodiment.

A switch 109 is configured to selectively couple either the first receiver circuit 105 or the second receiver circuit 107 to the antenna 101. In one embodiment, the switch 109 is a radio frequency switch having low conduction losses, and is used to couple the first receiver circuit 105 to the antenna 101 when receiving the first transmission signal 106, while coupling the second receiver circuit 107 to the antenna 101 when receiving the second transmission signal 108. Suitable switches include those with a pass through signal loss of less than 0.5 dB. An application processor 111, or other switching device, is used to selectively couple the receivers 105,107 to the antenna 101 by way of the switch using a switching algorithm 110.

In the exemplary embodiment of DVB—H/GPS, the first transmission signal 106 may be the DVB—H signal, which is a time-slotted multicast signal. As an electronic device employing the dual band antenna circuit 100 will generally be tuned to only one channel of the multi-cast signal, the dual band antenna circuit 100 may use idle time to toggle the switch 109 and acquire other signals. For instance, idle time between channel bursts in the DVB—H multicast signal may be used to capture GPS information when the switch 109 is configured to couple the single antenna 101 to the GPS receiver (e.g. second receiver circuit 107) at a frequency of between 0.14 Hz and 0.2 Hz. This corresponds to a switching duty cycle of between 0.015 and 0.04.

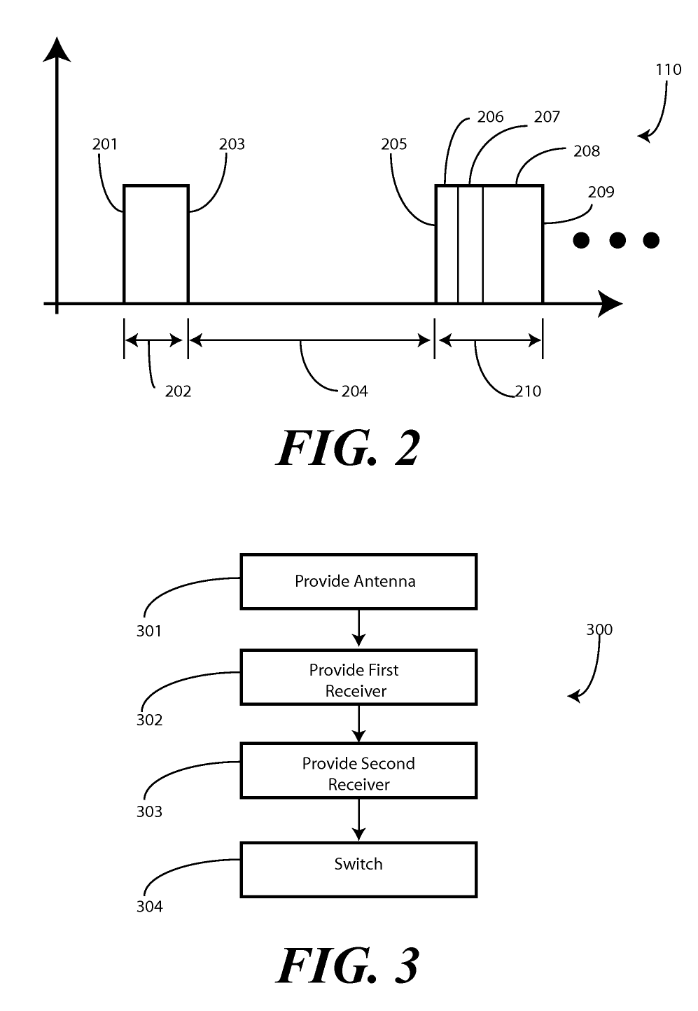

Turning now to FIG. 2, illustrated therein is a switching diagram 200 outlining the switching algorithm 110 for the exemplary embodiment. It will again be clear to those of ordinary skill in the art having the benefit of this disclosure that other time-slotted signal systems may be used in accordance with the invention, each having in turn a slightly different switching diagram.

In FIG. 2, at point 201, the application processor (111) couples the first receiver circuit (105), in this case the DVB—H receiver circuit, to the antenna (101). The antenna (101) remains connected to the first receiver circuit (105) for a first time period 202. Where the signal being received is a DVB—H signal, testing has shown that a period of around 140 ms is suitable for the first time period 202.

At point 203, the application processor (111) switches the switch (109) such that the antenna (101) is connected to the second receiver circuit (107). The antenna (101) remains connected to the second receiver circuit (107) for a second time period 204. In the exemplary embodiment, where the second receiver circuit (107) is a GPS or AGPS receiver, testing has shown that the second period can be more than six seconds, which is generally long enough for the mobile device to request location and Ephemeris data. This second time period 204 is typically enough time to enable Time to First Fix for an AGPS receiver.

At point 205, the application processor (111) switches the switch (109) back such that the antenna (101) is again coupled to the first receiver circuit (105). The first receiver circuit (105) remains coupled for a third signal duration 210, which covers both a time equivalent to the first time period 202 and an additional time for additional processing. In the DVB—H embodiment, for example, this time may be used for Entitlement Control Messaging (ECM) and other processing. Testing has shown that a third time period of about 350 ms allows for a 140 ms burst 206, 200 ms of ECM acquisition delay 207, and 10 ms jitter 208. The application processor (111) then again toggles the switch (109) at point 209, thereby repeating the process. Note that while first time period 202 is described as burst duration, in a continuous signal, the switch (109) would couple the antenna (101) to the first receiver circuit (105) for a duration sufficient to accommodate each of the burst, additional processing, and jitter.

Turning now to FIG. 3, illustrated therein is a method 300 for receiving at least two transmission signals with a single antenna (101). At step 301, an antenna is provided. The antenna has an antenna bandwidth spanning a transmission bandwidth associated with at least two transmission signals. The two transmission signals, as described above, may be a DVH-H and a GPS or AGPS signal.

At step 302, a first receiver circuit (105) is provided. The first receiver circuit (105) is configured to receive a first transmission signal. In the exemplary embodiment, the first transmission signal may be a DVB—H signal received from a terrestrial base station. At step 303, a second receiver circuit (107) is provided. The second receiver circuit (107) is configured to receive a second transmission signal. In the exemplary embodiment, the second transmission signal may be the GPS or AGPS signal.

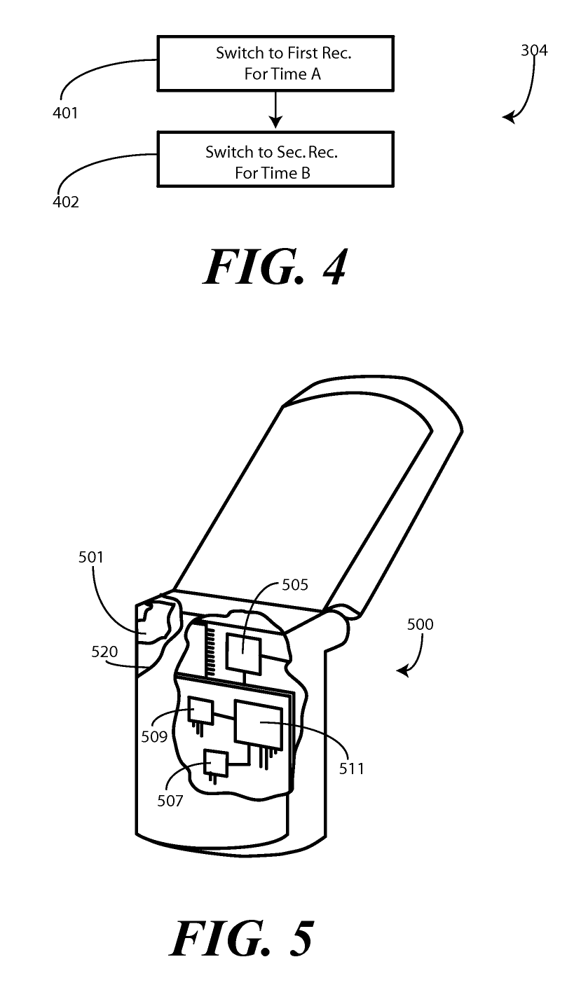

At step 304, a signal feed received from the antenna (101) is switched between the first receiver circuit (105) and the second receiver circuit (107). Turning to FIG. 4, illustrated therein are substeps of step 304. At step 401, the step of switching includes coupling the signal feed to the second receiver circuit (107) for a second receiver time duration. In the exemplary embodiment, this second receiver time duration is between 5 and 7 second.

At step 402, the step of switching includes coupling the signal feed to the first receiver circuit (105) for a first receiver time duration. In the exemplary embodiment, the first receiver time duration is between 100 and 200 ms. Using the exemplary embodiment, the signal feed is coupled to the first receiver circuit (105) at a frequency of between 0.14 and 0.2 Hz.

Turning now to FIG. 5, illustrated therein is one embodiment of a portable electronic device 500 employing an antenna circuit in accordance with the invention. The portable electronic device 500, which in one embodiment is a mobile telephone, includes a dual band antenna 501 having a reception bandwidth spanning at least a first transmission signal bandwidth and a second transmission signal bandwidth.

As with the embodiment of FIG. 1, a first receiver circuit 505 is operational within the first transmission signal bandwidth. As such, the first receiver circuit 505 is configured to receive and process signals transmitted within the first transmission signal bandwidth. A second receiver circuit 507, which is operational within a second signal transmission bandwidth, is configured to receive and process signals transmitted within the second transmission signal bandwidth.

A switch 509 selectively couples one of the first receiver circuit 505 and the second receiver circuit 507 to the dual band antenna 501 in a time-slotted manner. Using the exemplary embodiment, the first receiver circuit 505 may be configured to process DVB—H signals, while the second receiver circuit 507 may be configured to process GPS or AGPS signals. The switch 509 is thus configured to selectively couple the dual band antenna 501 to each receiver circuit in a time slotted manner so that both the DVB—H data burst and the GPS information may be received.

As illustrated in FIG. 5, one suitable location for the dual band antenna 501 within the portable electronic device 500 is within the upper frontal section 520. This location is suitable because a user generally holds the portable electronic device 500 at the base or in the middle. The upper frontal section 520 allows for minimal loading of the dual band antenna 501.

In one embodiment, at least one of the signals is a time-slotted multicast transmission signal. In the exemplary embodiment, where one signal is a DVB—H signal and another is a GPS or AGPS signal, the DVB—H signal operates as a time-slotted multicast signal. In the exemplary embodiment, each of these signals is within the L band, as the first receiver circuit 505 is a DVB—H receiver and the second receiver circuit 507 is an assisted global positioning system signal receiver.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A dual band antenna circuit, comprising:
a single antenna having an associated bandwidth spanning at least a first transmission signal bandwidth and a second transmission signal bandwidth;
a first receiver circuit configured to receive a first transmission signal characterized by the first transmission signal bandwidth;
a second receiver circuit configured to receive a second transmission signal characterized by the second transmission signal bandwidth; and
a switch configured to selectively couple one of the first receiver circuit or the second receiver circuit to the single antenna.

2. The dual band antenna circuit of claim 1, wherein the first transmission signal comprises a time-slotted multicast signal.

3. The dual band antenna circuit of claim 1, wherein the first transmission signal comprises a digital video broadcasting—handheld signal, further wherein the second transmission signal comprises one of a global positioning system signal or an assisted global positioning system signal.

4. The dual band antenna circuit of claim 3, wherein the switch is configured to couple the single antenna to the second receiver circuit at a frequency of between 0.14 Hz and 0.2 Hz.

5. The dual band antenna circuit of claim 4, wherein the switch is configured to couple the single antenna to the first receiver circuit at a duty cycle of between 0.015 and 0.04.

6. The dual band antenna circuit of claim 1, wherein the first transmission signal bandwidth and the second transmission signal bandwidth overlap.

7. The dual band antenna circuit of claim 6, wherein the first transmission signal bandwidth is between 1.575 GHz and 1.675 GHz.

8. The dual band antenna circuit of claim 1, wherein the associated bandwidth spans a spectrum of at least 100 MHz.

9. The dual band antenna circuit of claim 1, wherein the single antenna comprises one of an inverted-F antenna, a planar inverted-F antenna, or a folded inverted conformal antenna.

10. A method for receiving at least two transmission signals with a single antenna, the method comprising the steps of:
providing an antenna having an antenna bandwidth spanning a transmission bandwidth associated with each of the at least two transmission signals;
providing a first receiver configured to receive a first transmission signal of the at least two transmission signals;
providing a second receiver configured to receive a second transmission signal of the at least two transmission signals; and
switching a signal feed from the antenna between the first receiver and the second receiver.

11. The method of claim 10, wherein the step of switching the signal feed from the antenna between the first receiver and the second receiver comprises coupling the signal feed to the second receiver for between 5 and 7 seconds.

12. The method of claim 10, wherein the step of switching the signal feed from the antenna between the first receiver and the second receiver comprises coupling the signal feed to the first receiver for between 100 and 200 milliseconds.

13. The method of claim 10, wherein the step of switching the signal feed from the antenna between the first receiver and the second receiver comprises coupling the signal feed to the first receiver at a frequency of between 0.14 and 0.2 Hz.

14. A portable electronic device, comprising:
a dual band antenna having a reception bandwidth spanning a first transmission signal bandwidth and a second transmission signal bandwidth;
a first receiver circuit, operational in the first transmission signal bandwidth;
a second receiver circuit, operational in the second transmission signal bandwidth; and
a switch configured to selectively couple one of the first receiver circuit or the second receiver circuit to the dual band antenna in a time-slotted manner.

15. The portable electronic device of claim 14, wherein the dual band antenna is disposed in an upper frontal location within the portable electronic device.

16. The portable electronic device of claim 15, wherein the portable electronic device comprises a mobile telephone.

17. The portable electronic device of claim 14, wherein the first transmission signal bandwidth and the second transmission signal bandwidth are each within an L-band.

18. The portable electronic device of claim 14, wherein one of the first transmission signal bandwidth and the second transmission signal bandwidth is associated with a time-slotted multicast transmission signal.

19. The portable electronic device of claim 14, wherein the switch has associated therewith a pass through signal loss of less than 0.5 dB.

20. The portable electronic device of claim 14, wherein the first receiver circuit comprises a digital video broadcasting—handheld receiver, further wherein the second receiver circuit comprises one of a global positioning system signal or an assisted global positioning system signal receiver.
